(19) United States
(12) Patent Application Publication
(10) Pub. No.: US 2024/0051309 A1
(43) Pub. Date: Feb. 15, 2024

(54) PRINTING DEVICE

(71) Applicant: ALTEMIRA Co., Ltd., Tokyo (JP)

(72) Inventors: Shinichi OJIMA, Tokyo (JP); Kazunori IKEDA, Tokyo (JP); Kenji FUJINUMA, Tokyo (JP)

(73) Assignee: ALTEMIRA Co., Ltd., Tokyo (JP)

(21) Appl. No.: 18/022,507

(22) PCT Filed: Sep. 14, 2021
(86) PCT No.: PCT/JP2021/033705

§ 371 Date: Sep. 11, 2023

(30) Foreign Application Priority Data
Oct. 2, 2020 (JP) 2020-167505

(51) Int. Cl. B41J 3/407; B41J 2/21

(52) U.S. Cl. CPC B41J 3/40733; B41J 2/21

(57) ABSTRACT

A printing device includes: a holding part holding plural can bodies in a state in which the plural can bodies are arranged in one linear direction; a printing part performing printing on the can bodies held by the holding part; and a moving part causing the holding part to perform a reciprocating movement relative to the printing part in the one direction.

### TECHNICAL FIELD

The present invention relates to a printing device.

### BACKGROUND ART

For example, Patent Document 1 discloses a printing device for seamless cans, which includes a mandrel wheel, plural rotatable mandrels provided to the mandrel wheel, and an inkjet printing station for forming a printed image at least on a body part of the outer surface of a seamless can attached to the mandrel by inkjet printing. In the printing device, the inkjet printing is performed in at least one inkjet printing station, and plural inkjet heads are arranged in the inkjet printing station.

### CITATION LIST

### Patent Literature

Patent Document 1: Japanese Patent No. 5891602

### SUMMARY OF INVENTION

### Technical Problem

By the way, in the case where printing is performed while conveying plural can bodies, if, for example, the conveyance route of the can bodies includes a bending part, there is a high possibility that the conveyance of the can bodies is distorted due to the influence of the bending part. In addition, if the conveyance of the can bodies was distorted, there was a risk of causing defects in printing when printing was to be performed on the can body being conveyed.

An object of the present invention is to provide a printing device capable of suppressing occurrence of distortion in conveyance of the can bodies on which printing is to be performed.

### Solution to Problem

A printing device to which the present invention is applied includes: a holding part holding plural can bodies in a state in which the plural can bodies are arranged in one linear direction; a printing part performing printing on the can bodies held by the holding part; and a moving part causing the holding part to perform a reciprocating movement relative to the printing part in the one direction.

Here, the holding part may include a first holding part provided at one end side in a crossing direction crossing the one direction to hold the plural can bodies, and a second holding part provided at the other end side in the crossing direction to hold the plural can bodies.

In addition, the first holding part may rotate the can bodies held by the first holding part in a specific direction, and, when the first holding part rotates the can bodies in the specific direction, the second holding part may rotate the can bodies held by the second holding part in a direction opposite to the specific direction.

Moreover, a portion of the first holding part, where the can bodies are attached and detached, may be provided at the one end side, and a portion of the second holding part, where the can bodies are attached and detached, may be provided at the other end side.

Furthermore, the printing part may include: a first printing part including a first color part performing printing in a first color on the can bodies and a second color part performing printing in a second color on the can bodies, the can bodies being held by the first holding part; and a second printing part including a first color part performing printing in the first color on the can bodies and a second color part performing printing in the second color on the can bodies, the can bodies being held by the second holding part.

In addition, the moving part may move the holding part from one side to the other side in the one direction when the first printing part performs printing on the can bodies, and may move the holding part from the other side to the one side when the second printing part performs printing on the can bodies.

Moreover, in the first printing part, the first color part and the second color part may be arranged in this order from the one side to the other side, and, in the second printing part, the first color part and the second color part may be arranged in this order from the other side to the one side.

Furthermore, the printing device may also include: a first mechanical part disposed at one side of the printing part in the one direction to supply and discharge the can bodies to and from the holding part; and a second mechanical part disposed at the other side of the printing part in the one direction to supply and discharge the can bodies to and from the holding part, wherein the moving part causes the holding part to perform a reciprocating movement with respect to the printing part with the first mechanical part and the second mechanical part as turning points.

### Advantageous Effects of Invention

According to the present invention, it is possible to provide a printing device capable of suppressing occurrence of distortion in conveyance of the can bodies on which printing is to be performed.

### BRIEF DESCRIPTION OF DRAWINGS

FIG. 1 is an overall view of a printing device in the exemplary embodiment;

FIG. 2 is a partial enlarged view of a conveyance part in the exemplary embodiment;

FIG. 3 shows an overview of a printing part in the exemplary embodiment;

FIG. 4 shows an example of an operation flow of the printing device in the exemplary embodiment;

FIG. 5 is an illustration diagram of operations of the printing device in the exemplary embodiment;

FIG. 6 is another illustration diagram of operations of the printing device in the exemplary embodiment;

FIG. 7 is another illustration diagram of operations of the printing device in the exemplary embodiment; and

FIG. 8 is another illustration diagram of operations of the printing device in the exemplary embodiment.

### DESCRIPTION OF EMBODIMENT

Hereinafter, an exemplary embodiment for putting the present invention into practice will be described with reference to attached drawings.

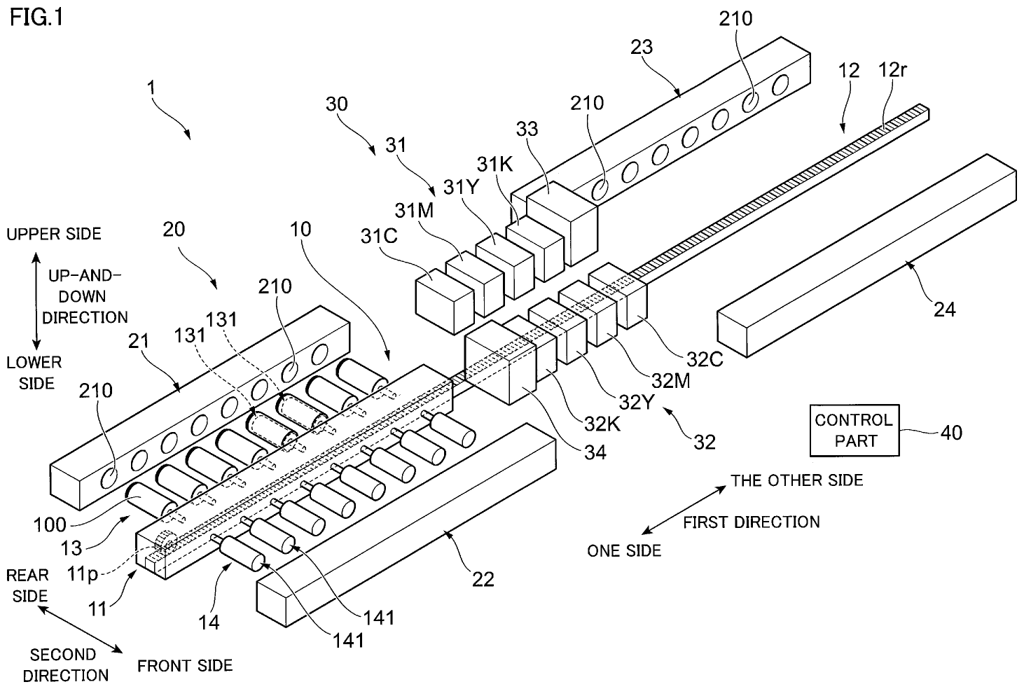

FIG. 1 is an overall view of a printing device 1 in the exemplary embodiment.

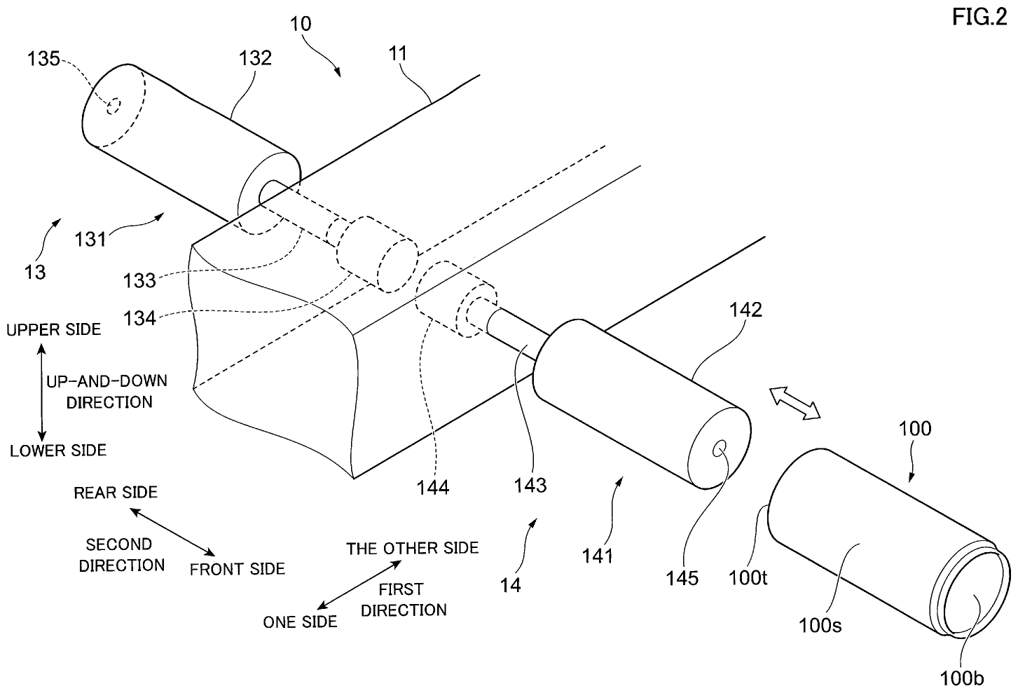

FIG. 2 is a partial enlarged view of a conveyance part 10 in the exemplary embodiment.

As shown in FIG. 1, the printing device 1 includes: a conveyance part 10 that holds plural can bodies 100 and conveys the plural can bodies 100; a supply/discharge part 20 that supplies the can bodies 100 to the conveyance part 10 and discharges the can bodies 100 from the conveyance part 10; a printing part 30 that performs printing on the can bodies 100; and a control part 40 that generally controls the conveyance part 10, the supply/discharge part 20, and the printing part 30.

In addition, as shown in FIG. 2, the can body 100 to be printed by the printing device 1 of the exemplary embodiment is formed into the bottomed cylindrical shape. The can body 100 has a side surface 100s, which is a cylindrical portion. In addition, the can body 100 has an opening part 100 t at one end side of the axial direction, to which a can lid is attached, and a bottom part 100b at the other end side of the axial direction, which is closed. Moreover, the can body 100 of the exemplary embodiment is made of metal. Examples of the material of the can body 100 can include metals such as aluminum, an aluminum alloy, and steel.

Then, as shown in FIG. 1, the printing device 1 of the exemplary embodiment holds the plural can bodies 100 in a state in which the plural can bodies 100 are arranged in one linear direction, causes the plural can bodies 100 being held to perform a reciprocating movement along the one direction, and performs printing on each of the can bodies 100 being held by the printing part 30.

Hereinafter, each configuration will be described in detail.

Note that, as shown in FIG. 1, the direction in which the can bodies 100 are conveyed is referred to as the “first direction,” the left side of the printing device 1 in the first direction on the page is referred to as the “one side,” and the right side of the printing device 1 on the page is referred to as “the other side.” In addition, the direction crossing (for example, orthogonally crossing) the first direction is referred to as the “second direction,” the lower side of the printing device 1 in the second direction on the page is referred to as the “front side,” and the upper side of the printing device 1 on the page is referred to as the “rear side.” Further, the direction along the vertical direction of the printing device 1 is referred to as the “up-and-down direction.”

### [Conveyance Part 10]

As shown in FIG. 1, the conveyance part 10 includes: a moving part 11 that moves; a guide part 12 that guides the movement of the moving part 11; a first holding part 13 that is supported by the moving part 11 and holds the can bodies 100; and a second holding part 14 that is supported by the moving part 11 and holds the can bodies 100.

The moving part 11 includes a not-shown drive motor and a pinion gear 11p on the shaft of the drive motor. The pinion gear 11p connects to a rack gear 12r, which is provided in the guide part 12 and will be described later. The moving part 11 moves along the first direction from the one side to the other side by rotation of the pinion gear 11p in one direction by the drive motor. In addition, the moving part 11 moves along the first direction from the other side to the one side by the rotation of the pinion gear 11p in the other direction by the drive motor.

Then, the moving part 11 of the exemplary embodiment moves the first holding part 13 and the second holding part 14 that are supported by the moving part 11 to a position facing the supply/discharge part 20 or a position facing the printing part 30.

The guide part 12 is provided to extend along the first direction, and includes the rack gear 12r which engages with the pinion gear 11p of the moving part 11. Then, the guide part 12 guides the movement of the moving part 11 along the first direction.

In the exemplary embodiment, the guide part 12 is laid across the range from the supply/discharge part 20 to the printing part 30. The guide part 12 and the moving part 11 cause the first holding part 13 and the second holding part 14 to perform the reciprocating movement with respect to the printing part 30 with a one-side first supply/discharge part 21 and a one-side second supply/discharge part 22 (for instance, an example of a first mechanical part), which will be described later, of the supply/discharge part 20 and an other-side first supply/discharge part 23 and an other-side second supply/discharge part 24 (for instance, an example of a second mechanical part), which will be described later, of the supply/discharge part 20 as turning points.

In this way, the conveyance part 10 of the exemplary embodiment conveys the can bodies 100 held by the first holding part 13 and the second holding part 14 by using a route constituted only by a straight line without a route of an arc-shaped bending part.

The first holding part 13 is provided on the rear side in the second direction. The first holding part 13 includes plural first holding bodies 131. The plural first holding bodies 131 are arranged in line with substantially equally spaced intervals in the first direction. In addition, each of the first holding bodies 131 is provided to protrude from the moving part 11 toward the rear side in the second direction. Further, each of the first holding bodies 131 extends along substantially the horizontal direction.

As shown in FIG. 2, the first holding body 131 includes: a mandrel 132 that holds the can body 100; a shaft 133 that rotatably supports the mandrel 132; a holding body gear 134 provided to the shaft 133; and an air vent 135 provided to the mandrel 132.

The mandrel 132 is formed into the columnar shape. Then, The mandrel 132 is inserted into the can body 100 from the opening part 100t side of the can body 100 to hold the can body 100. The first holding body 131 of the exemplary embodiment having the mandrel 132 extends along substantially the horizontal direction, as described above. Consequently, in the state where the mandrel 132 holds the can body 100, the axis of the can body 100 is substantially along the horizontal direction.

The shaft 133 is attached with the mandrel 132 at one end side, and the holding body gear 134 at the other end side. The shaft 133 is rotatably supported by the moving part 11 via a not-shown bearing.

The holding body gear 134 receives the driving force from a not-shown drive motor. Then, the holding body gear 134 transmits the driving force of rotation to the shaft 133 and the mandrel 132.

In the exemplary embodiment, the holding body gears 134 of the respective plural first holding bodies 131 are commonly connected to a not-shown pulley. The pulley rotated by the drive motor causes the mandrels 132 of the respective plural first holding bodies 131 to synchronize with one another to rotate in the same direction.

Note that the first holding body 131 may individually include a drive motor to rotate the holding body gear 134. In this case, synchronous control using a control signal from the control part 40 can be performed to rotate the plural drive motors constituted by the plural first holding bodies 131 in the same direction at a predetermined timing.

The air vent 135 is connected to a not-shown air supply and discharge device that supplies and discharges air. When the can body 100 is attached to the mandrel 132 to be held, the air vent 135 sucks air between the mandrel 132 and the can body 100. This firmly fastens the can body 100 to the mandrel 132 without displacement even if the mandrel 132 rotates or the mandrel 132 is conveyed. In addition, when the can body 100 is discharged from the mandrel 132, the air vent 135 supplies compressed air between the mandrel 132 and the can body 100. Consequently, the can body 100 is pushed by the compressed air and detached from the mandrel 132.

As shown in FIG. 1, the second holding part 14 is provided on the front side in the second direction. The second holding part 14 includes plural second holding bodies 141. The plural second holding bodies 141 are arranged in line with substantially equally spaced intervals in the first direction. In addition, each of the second holding bodies 141 is provided to protrude from the moving part 11 toward the front side in the second direction. Further, each of the second holding bodies 141 extends along substantially the horizontal direction.

As shown in FIG. 2, the second holding body 141 includes: a mandrel 142 that holds the can body 100; a shaft 143 that rotatably supports the mandrel 142; a holding body gear 144 provided to the shaft 143; and an air vent 145 provided to the mandrel 142.

The basic configuration of these component parts of the second holding body 141 are similar to the mandrel 132, the shaft 133, the holding body gear 134 and the air vent 135, respectively, of the first holding body 131 described above.

In the second holding bodies, the holding body gears 144 of the respective plural second holding bodies 141 are commonly connected to a not-shown pulley. The pulley rotated by the drive motor causes the mandrels 142 of the respective plural second holding bodies 141 to synchronize with one another to rotate in the same direction.

Note that, in the second holding bodies 141, each of the second holding bodies 141 may individually include a drive motor to rotate the mandrel 142.

Then, in the exemplary embodiment, in the case of viewing from the front side or the rear side in the second direction, the rotation direction of the mandrel 142 of the second holding body 141 is opposite to the rotation direction of the mandrel 132 of the first holding body 131.

Subsequently, the relationship between the arrangement of the aforementioned first holding part 13 and second holding part 14 will be described.

As shown in FIG. 1, the first holding part 13 and the second holding part 14 in the exemplary embodiment are provided in line symmetry with the longitudinal direction of the moving part 11 as the axis of symmetry when the conveyance part 10 is viewed from the up-and-down direction.

The first holding part 13 is provided on the rear side in the second direction (for instance, an example of the one end side) to hold the plural can bodies 100. The second holding part 14 is provided on the front side in the second direction (for instance, an example of the other end side) to hold the plural can bodies 100.

Further, the first holding part 13 and the second holding part 14 are arranged on the same horizontal surface including the moving part 11.

In addition, in the exemplary embodiment, the number of first holding bodies 131 provided to the first holding part 13 and the number of second holding bodies 141 provided to the second holding part 14 are the same. Moreover, the shaft 143 of the second holding body 141 and the shaft 133 of the first holding body 131, which are symmetrically arranged, are provided on the same virtual axis along the second direction.

Further, the mandrel 132 of the first holding body 131 provided to the first holding part 13 protrudes toward the rear side in the second direction, and the mandrel 142 of the second holding body 141 provided to the second holding part 14 protrudes toward the front side in the second direction. In other words, the portions in the first holding part 13, where the can bodies 100 are attached and detached, are provided at the rear side in the second direction (for instance, an example of one end side), and the portions in the second holding part 14, where the can bodies 100 are attached and detached, are provided at the front side in the second direction (for instance, an example of the other end side). Consequently, in each of the first holding part 13 and the second holding part 14, the portions for attaching and detaching the can bodies 100 are arranged at the outer side, and thereby workability when the can bodies 100 are attached and detached (in other words, supplied and discharged) is improved.

In the exemplary embodiment, when the mandrel 132 of the first holding part 13 (refer to FIG. 2) is rotated, the mandrel 142 of the second holding part 14 (refer to FIG. 2) is also rotated. In this case, when the rotation direction of the mandrel 132 of the first holding part 13 as viewed from the second direction is assumed to be a specific direction, the rotation direction of the mandrel 142 of the second holding part 14 is opposite to the specific direction. In addition, the rotation speed and the timing of rotation are synchronized between the mandrel 132 of the first holding part 13 and the mandrel 142 of the second holding part 14. Consequently, in the case where the conveyance part 10 is captured as a whole, the effect of vibration and torsion associated with the rotation of the mandrel 132 in the first holding part 13 is offset by the mandrel 142 in the second holding part 14, which rotates oppositely with the mandrel 132 of the first holding part 13.

Note that the first holding part 13 and the second holding part 14 may be driven by a single drive motor. In this case, in the first holding part 13, all of the plural first holding bodies 131 are connected to, for example, one pulley. In addition, in the second holding part 14, all of the plural second holding bodies 141 are connected to, for example, the other pulley. Then, the single drive motor rotates the one pulley and the other pulley so that the rotation directions thereof are opposite to each other.

### [Supply/Discharge Part 20]

As shown in FIG. 1, the supply/discharge part 20 includes a one-side first supply/discharge part 21, which is disposed on one side and on the rear side, and a one-side second supply/discharge part 22, which is disposed on one side and on the front side. In addition, the supply/discharge part 20 includes an other-side first supply/discharge part 23, which is disposed on the other side and on the rear side, and an other-side second supply/discharge part 24, which is disposed on the other side and on the front side. Note that, in the case where the one-side first supply/discharge part 21, the one-side second supply/discharge part 22, the other-side first supply/discharge part 23, and the other-side second supply/discharge part 24 are not particularly distinguished, these are referred to as the supply/discharge part 20 to be described.

The supply/discharge part 20 is movable in the second direction. The one-side first supply/discharge part 21 is movable toward and away from the first holding part 13 on the one side. The one-side second supply/discharge part 22 is movable toward and away from the second holding part 14 on the one side. In addition, the other-side first supply/discharge part 23 is movable toward and away from the first holding part 13. The other-side second supply/discharge part 24 is movable toward and away from the second holding part 14.

The supply/discharge part 20 includes a can body grasping part 210 that grips the outside of the can body 100 and grasps the can body 100. The supply/discharge part 20 includes the plural can body grasping parts 210. The number of can body grasping parts 210 corresponds to the number of first holding bodies 131 of the first holding part 13 or the number of second holding bodies 141 of the second holding part 14.

Then, the can body grasping part 210 grasps the can body 100 sent from a not-shown storage part where the can bodies 100 before printing are stored, and supplies the can body 100 to the first holding part 13 or the second holding part 14. In addition, the can body grasping part 210 grasps the printed can body 100, on which the printing has been performed, to discharge the can body 100 from the first holding part 13 or the second holding part 14, and sends the can body 100 to a collection part where the printed can bodies 100 are collected.

### [Printing Part 30]

As shown in FIG. 1, the printing part 30 includes a first printing unit 31 disposed on the rear side in the second direction, and a second printing unit 32 disposed on the front side in the second direction.

The first printing unit 31 and the second printing unit 32 perform printing on the can body 100 that has been moved by the moving part 11. More specifically, the first printing unit 31 performs printing on the can body 100 held by the first holding part 13 moved by the moving part 11. In addition, the second printing unit 32 performs printing on the can body 100 held by the second holding part 14 moved by the moving part 11. Note that the printing range by the printing part 30 is the surface of the can body 100, and the side surface 100s of the can body 100 (refer to FIG. 2).

The printing part 30 of the exemplary embodiment is installed at a position fixed in the first direction, the second direction, and the up-and-down direction, and does not move from the predetermined position. Then, the printing part 30 performs printing on the can body 100 conveyed by the conveyance part 10. In the printing device 1 in the exemplary embodiment, the position of the printing part 30, which is an ink ejection side to be described later, is fixed, and thereby the printing accuracy is improved as compared to a configuration in which the ink ejection side moves in performing printing.

### (First Printing Unit 31)

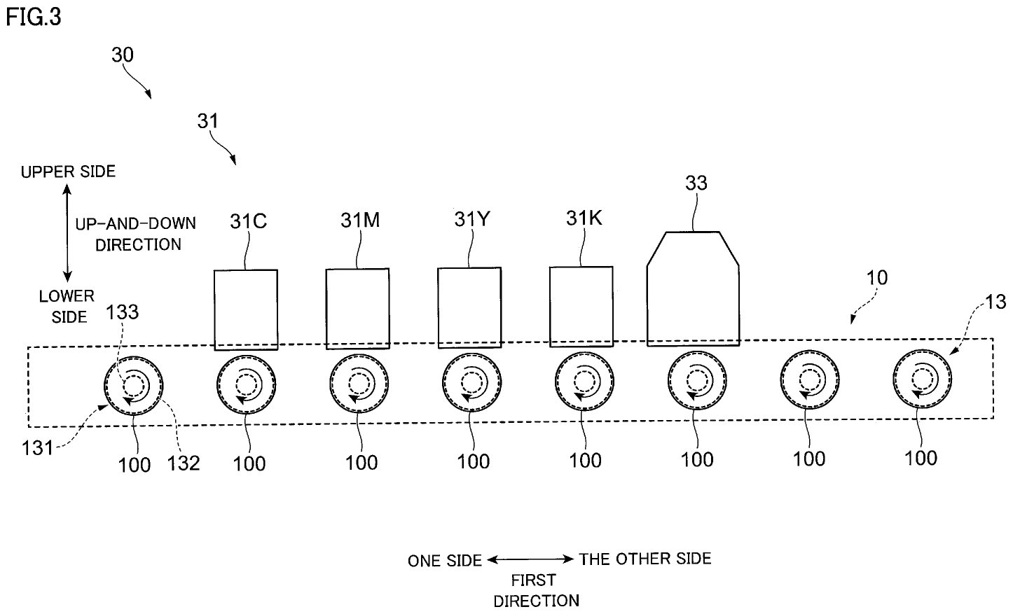

FIG. 3 shows an overview of the printing part 30 in the exemplary embodiment.

Note that FIG. 3 is a diagram viewing the printing part 30 from the front side to the rear side in the second direction, and the illustration of the second printing unit 32 is omitted.

The first printing unit 31 performs printing on the can body 100 using the inkjet printing method. The inkjet printing method refers to an image formation method performed by ejecting ink from inkjet heads to attach the ink to the can body 100. The printing by the inkjet printing method can use publicly known methods including, for example, the piezo system, the thermal (bubble) system, and the continuous system.

Then, as shown in FIG. 3, the first printing unit 31 (for instance, an example of a first printing part) includes: a first cyan head 31C (for instance, an example of a first color part) that ejects cyan ink; a first magenta head 31M (for instance, a second color part) that ejects magenta ink; a first yellow head 31Y that ejects yellow ink; and a first black head 31K that ejects black ink. Note that, in the case where the first cyan head 31C, the first magenta head 31M, the first yellow head 31Y, and the first black head 31K are not particularly distinguished, these heads are simply referred to as “first inkjet heads.”

Further, the first printing unit 31 includes a first light irradiation part 33 that irradiates the can body 100, on which the printing by the first inkjet heads has been performed, with light.

The first inkjet heads in the exemplary embodiment including four colors of the first cyan head 31C, the first magenta head 31M, the first yellow head 31Y, and the first black head 31K perform printing on the can bodies 100 by use of the ultraviolet cure ink.

Note that, in the exemplary embodiment, the case in which the first inkjet heads including four colors of cyan, magenta, yellow, and black, were provided was shown as an example; however, an inkjet head ejecting ink of a special color, such as a corporate color, or an inkjet head for forming a white layer may be further provided.

Then, the first inkjet heads of four colors are arranged in line along the moving direction of the can body 100. In the first printing unit 31 of the exemplary embodiment, from one side to the other side in the first direction, the first cyan head 31C, the first magenta head 31M, the first yellow head 31Y, and the first black head 31K are arranged in line in this order.

In addition, each of the first inkjet heads is disposed along a direction orthogonal to (crossing) the moving direction of the can body 100. Specifically, the first inkjet heads are arranged so that ejection holes that eject ink are along the axial direction of the can body 100. Moreover, the first inkjet heads are provided over the entire side surface 100s (refer to FIG. 2) between the opening part 100t and the bottom part 100b of the can body 100 in the axial direction thereof.

Then, when the first inkjet heads perform printing, the can body 100 does not move in the axial direction of the can body 100. On the other hand, when the first inkjet heads perform printing, the can body 100 rotates in the circumferential direction. Note that, in the exemplary embodiment, since an image is formed on the entire side surface 100s (refer to FIG. 2) of the can body 100, the can body 100 makes at least one rotation in the circumferential direction when the first inkjet heads perform printing.

Then, in the exemplary embodiment, each of the can bodies 100 conveyed by the moving part 11 stops at the underside of each of the first inkjet heads. More specifically, the moving part 11 in the exemplary embodiment conveys the plural can bodies 100 so that one of the can bodies 100 is disposed at the installation location of each of the plural first inkjet heads. At this time, as for the position in the moving direction of the moving part 11, the movement of the can body 100 stops, but the can body 100 rotates in the circumferential direction. In other words, the can body 100 rotates with the axial direction as the rotation axis.

In addition, in the exemplary embodiment, the can body 100 moves in a state in which the axial direction of the can body 100 extends along the horizontal direction, and an uppermost part of the outer circumferential surface of the can body 100 faces upward in the vertical direction. Then, each of the first inkjet heads in the exemplary embodiment ejects ink toward the outer circumferential surface of the can body 100 from the upper side to the lower side, to thereby perform printing onto the can body 100.

Then, the moving part 11 moves each can body 100 so that each can body 100 sequentially stops at the installation location of each first inkjet head; accordingly, the first inkjet heads of four colors perform color printing on one can body 100 using the ink of four colors.

In the first printing unit 31 of the exemplary embodiment, the first holding part 13 is moved from one side to the other side with respect to the first printing unit 31, and printing in each color is sequentially performed on the can body 100 held by the first holding part 13. In the exemplary embodiment, when the printing on the can body 100 by the one first inkjet head is finished, the moving part 11 moves the can body 100 toward one of other first inkjet heads located downstream of the one first inkjet head in the moving direction of the moving part 11. Then, the one of other first inkjet heads performs printing onto the can body 100.

Then, the first inkjet heads of the first printing unit 31 eject ink to the can body 100 from above in the process in which the can body 100 passes through below the four first inkjet heads, to thereby perform printing on the can body 100. In this case, the cyan ink, the magenta ink, the yellow ink, and the black ink are provided in this order from the surface of the can body 100 toward the direction away from the surface.

The first light irradiation part 33 of the exemplary embodiment is disposed on the other side of the first black head 31K. In other words, when the printing is performed on the can body 100 held by the first holding part 13, the first light irradiation 33 is disposed downstream of the four first inkjet heads in the moving direction of the moving part 11.

Then, the first light irradiation part 33 irradiates the can body 100 with ultraviolet light. When the first light irradiation part 33 irradiates the can body 100 with ultraviolet light, the can body 100 rotates around the axial direction as the rotation axis. The first light irradiation part 33 cures the image formed on the outer circumferential surface of the can body 100.

Note that, to perform printing on the can body 100, thermosetting ink may also be used. In this case, for example, a heat source such as a heating lamp, not a light source, can be installed at the location where the first light irradiation part 33 is provided.

### (Second Printing Unit 32)

As shown in FIG. 1, the second printing unit 32 (for instance, an example of a second printing part) includes: a second cyan head 32C (for instance, an example of a first color part) that ejects cyan ink; a second magenta head 32M (for instance, a second color part) that ejects magenta ink; a second yellow head 32Y that ejects yellow ink; and a second black head 32K that ejects black ink. Note that, in the case where the second cyan head 32C, the second magenta head 32M, the second yellow head 32Y, and the second black head 32K are not particularly distinguished, these heads are simply referred to as “second inkjet heads.”

Further, the second printing unit 32 includes a second light irradiation part 34 that irradiates the can body 100, on which the printing by the second inkjet heads has been performed, with light.

The basic configuration of the second inkjet heads and the second light irradiation part 34 of the second printing unit 32 is similar to the first inkjet heads and the first light irradiation part 33 of the first printing unit 31. However, the second inkjet heads and the second light irradiation part 34 of the second printing unit 32 differ from the first printing unit 31 in the arrangement of each component in the first direction.

In the second printing unit 32, from the other side to the one side in the first direction, the second cyan head 32C, the second magenta head 32M, the second yellow head 32Y, and the second black head 32K are arranged in line in this order. This color sequence of the second inkjet heads is in the relation opposite to the color sequence in the first direction of the first inkjet heads of the first printing unit 31 as viewed from the front side or the rear side in the second direction.

On the other hand, in the second printing unit 32, the second holding part 14 is moved from the other side to the one side with respect to the second printing unit 32, and printing in each color is sequentially performed on the can body 100 held by the second holding part 14. In the exemplary embodiment, when the printing on the can body 100 by the one second inkjet head is finished, the moving part 11 moves the can body 100 toward one of other second inkjet heads located downstream of the one second inkjet head in the moving direction of the moving part 11. Then, the one of other second inkjet heads performs printing onto the can body 100. In this way, in the exemplary embodiment, in the process in which the can body 100 passes through below the four second inkjet heads, ink is ejected to the can body 100 from above, to thereby perform printing on the can body 100.

Then, as described above, the second inkjet heads of the second printing unit 32 perform printing on the can body 100 in the process in which the can body 100 passes through below the four second inkjet heads. In this case, the cyan ink, the magenta ink, the yellow ink, and the black ink are provided in this order from the surface of the can body 100 toward the direction away from the surface.

In this manner, in the printing device 1 of the exemplary embodiment, the second printing unit 32 and the first printing unit 31 are configured so that the order of placing ink of each color onto the can body 100 is the same. Consequently, in the printing device 1 of the exemplary embodiment, the printing conditions of the second printing unit 32 and the first printing unit 31 are the same, and thereby the difference in the color of the images between the second printing unit 32 and the first printing unit 31 is suppressed.

### [Control Part 40]

The control part 40 shown in FIG. 1 includes: a CPU (Central Processing Unit), which is a computing means; a ROM (Read Only Memory), which is a storage area that stores programs such as the BIOS (Basic Input Output System); and a RAM (Random Access Memory), which is a program execution area. In addition, the control part 40 also includes a non-volatile memory, such as an HDD (Hard Disk Drive) and a flash memory, which is a storage area for various programs such as an OS (Operating System) and applications, input data for various programs, output data from various programs, etc. Note that the control part 40 may include plural CPUs, and the plural CPUs may cooperate to perform computing processing.

The control part 40 controls operations of the conveyance part 10, the supply/discharge part 20, and the printing part 30 based on the contents of predetermined programs, and operation information such as the positions of the moving part 11, etc., provided by not-shown various sensors.

Subsequently, operations of the printing device 1 in the exemplary embodiment will be specifically described.

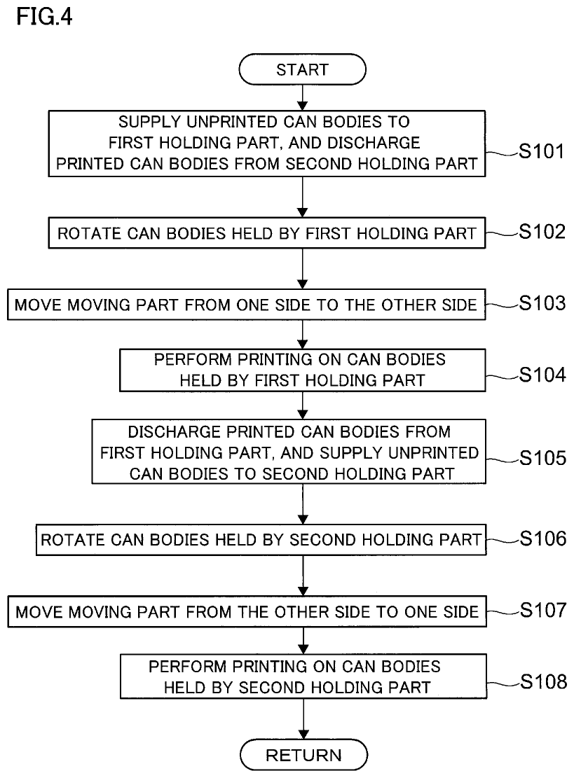

FIG. 4 shows an example of an operation flow of the printing device 1 in the exemplary embodiment.

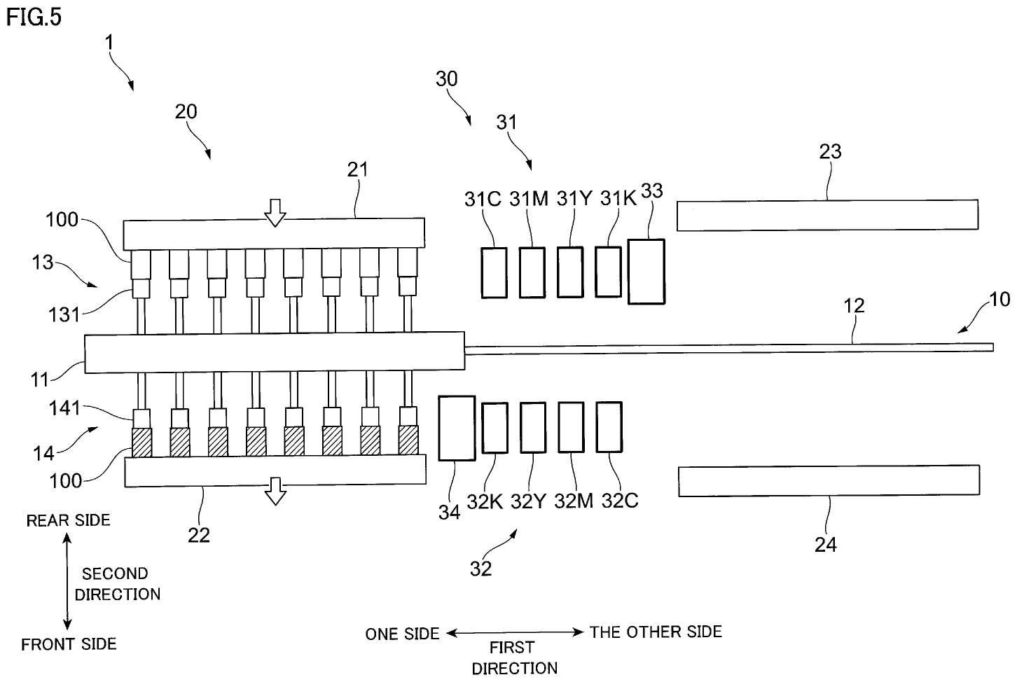

FIGS. 5 6, 7, and 8 are illustration diagrams of operations of the printing device 1 in the exemplary embodiment.

Note that each of FIGS. 5 through 8 is a diagram in which the printing device 1 is viewed from the upper side to the lower side in the up-and-down direction.

As shown in FIG. 4, unprinted can bodies 100 are supplied to the first holding part 13, and the printed can bodies 100 are discharged from the second holding part 14 (S101).

Specifically, as shown in FIG. 5, the moving part 11 positions the first holding part 13 and the second holding part 14 in such a way that the one-side first supply/discharge part 21 and the one-side first supply/discharge part 22 on the one side face each other. Then, the one-side first supply/discharge part 21 receives the can bodies 100 from the storage part where the unprinted can bodies 100 are stored, and fits the can bodies 100 over the respective first holding bodies 131 of the first holding part 13. Moreover, the one-side second supply/discharge part 22 takes the printed can bodies 100 out of the respective second holding bodies 141 of the second holding part 14, and sends thereof to the not-shown collection part where the printed can bodies 100 are collected.

Consequently, the can bodies 100 are held by the respective first holding bodies 131 of the first holding part 13, and the can bodies 100 are not held by the respective second holding bodies 141 of the second holding part 14.

Next, as shown in FIG. 4, the can bodies 100 held by the first holding part 13 are rotated (S102).

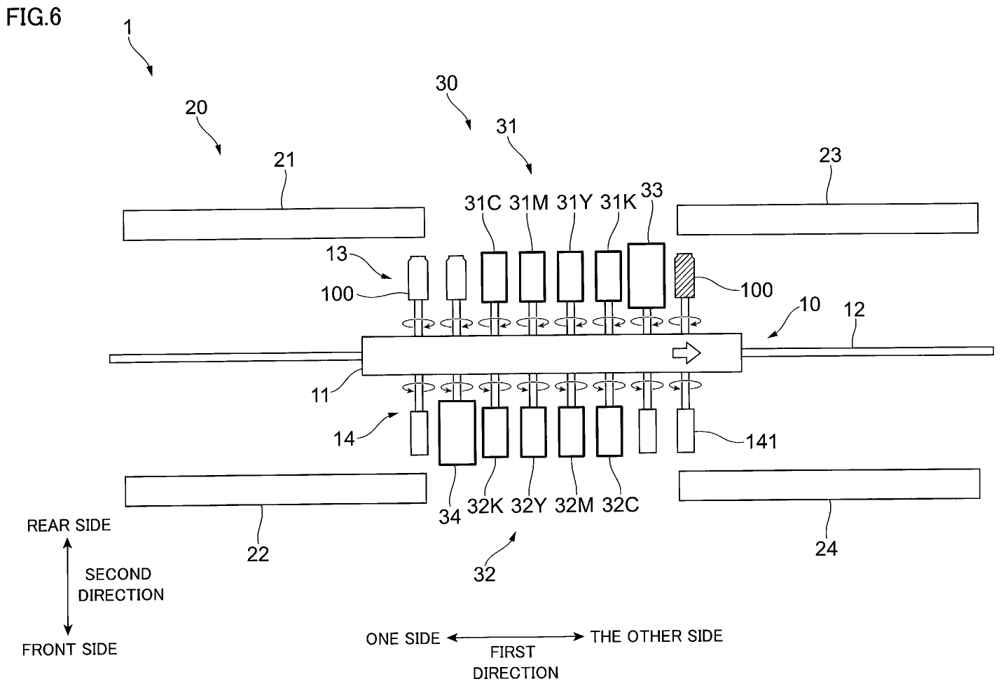

In the exemplary embodiment, the first holding part 13 has the plural first holding bodies 131, and holds the plural can bodies 100. Then, the first holding part 13 synchronizes all of the plural can bodies 100 with one another, and rotates thereof around the axial direction as the rotation axes. In addition, in the exemplary embodiment, the plural second holding bodies 141 of the second holding part 14 rotate simultaneously with the rotation of the plural first holding bodies 131 of the first holding part 13. At this time, as viewed from one of the front side and the rear side in the second direction, the first holding body 131 and the second holding body 141 rotate in the directions opposite to each other (refer to FIG. 6).

Then, as shown in FIG. 4, the moving part 11 is moved from the one side to the other side (S103).

Thus, the plural can bodies 100 held by the first holding part 13 are conveyed to the position where the first printing unit 31 is installed.

Then, the moving part 11 moves, for example, the can body 100 from among the plural can bodies 100, which is positioned at the end of the other side in the first direction (hereinafter referred to as “one can body 100”) to the position below the first cyan head 31C, and temporarily stops the conveyance of the can bodies 100 in the first direction.

Thereafter, as shown in FIG. 4, printing is performed on the can bodies 100 held by the first holding part 13 (S104).

Specifically, as shown in FIG. 6, in the state in which the conveyance of the can bodies 100 by the moving part 11 is stopped, the first holding part 13 rotates the one can body 100 at least once in the circumferential direction, and the first cyan head 31C performs printing onto the one can body 100.

Thereafter, the moving part 11 moves the one can body 100 to the position below the first magenta head 31M, which is adjacent to the first cyan head 31C, and temporarily stops the conveyance of the can bodies 100 in the first direction. In this state, the can body 100, from among the plural can bodies 100 held by the first holding part 13, positioned on the one side of the one can body 100 (hereinafter referred to as “other can body 100”) is positioned below the first cyan head 31C.

Then, the first holding part 13 rotates the one can body 100 at least once in the circumferential direction, and the first magenta head 31M performs printing onto the one can body 100. In addition, the first holding part 13 rotates the other can body 100 at least once in the circumferential direction, and the first cyan head 31C performs printing onto the other can body 100.

Thereafter, the moving part 11 conveys the one can body 100 to the position below the first yellow head 31Y, and the first yellow head 31Y performs printing onto the one can body 100. Furthermore, the moving part 11 conveys the one can body 100 to the position below the first black head 31K, and the first black head 31K performs printing onto the one can body 100.

In this way, the printing device 1 performs printing in four colors, cyan, magenta, yellow, and black, onto the one can body 100. Similarly, the printing device 1 performs printing in these four colors onto the other can body 100, and similarly performs printing in the four colors sequentially onto the can body 100 positioned on the one side of the other can body 100.

Then, in the state of being located below the first light irradiation part 33, the one can body 100 is irradiated by the first light irradiation part 33 with ultraviolet light while being rotated at least once in the circumferential direction. This cures the inks of cyan, magenta, yellow, and black on the one can body 100. Similarly, the other can body 100 is located below the first light irradiation part 33, and thereby the other can body 100 is irradiated with ultraviolet light, to thereby cure the ink.

As described above, the printing on all of the plural can bodies 100 held by the first holding part 13 is completed.

Note that, when the moving part 11 moves from the one side to the other side, and printing is performed by the first printing unit 31 on the can bodies 100 held by the first holding part 13, the second holding part 14 passes through the second printing unit 32. However, the second holding part 14 in the exemplary embodiment holds no can body 100, and the printing by the second printing unit 32 is not performed for the second holding part 14.

Thereafter, as shown in FIG. 4, the printed can bodies 100 are discharged from the first holding part 13, and unprinted can bodies 100 are supplied to the second holding part 14 (S105).

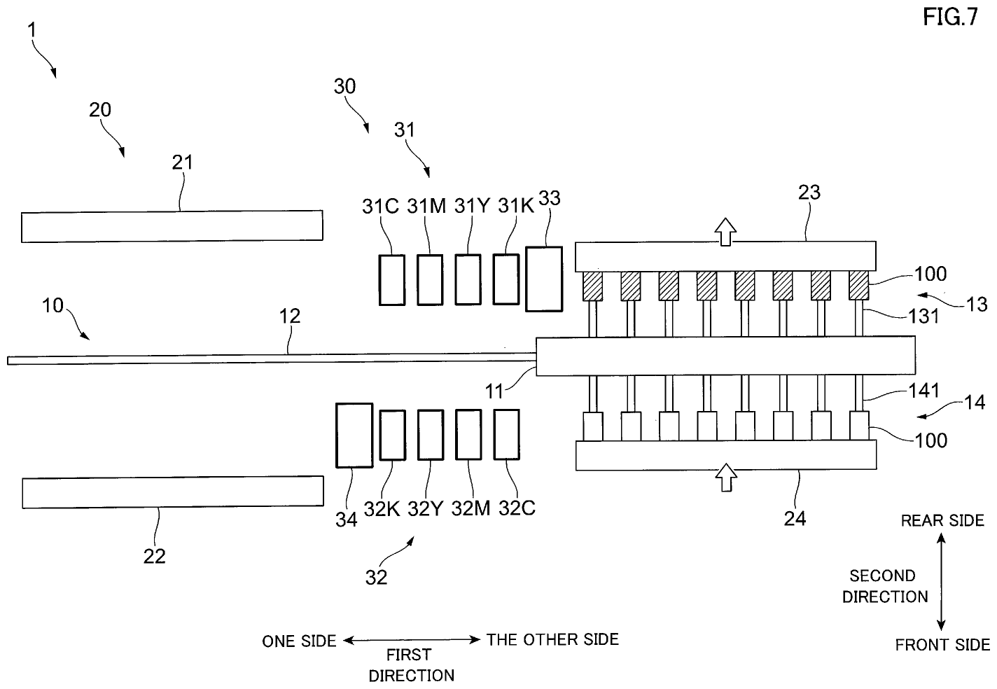

Specifically, when the moving part 11 moves the first holding part 13 from the one side to the other side to complete the printing on the can bodies 100 held by the first holding part 13, the moving part 11 positions the first holding part 13 and the second holding part 14 in such a way that the other-side first supply/discharge part 23 and the other-side second supply/discharge part 24 face each other as shown in FIG. 7.

Then, the other-side first supply/discharge part 23 takes the printed can bodies 100 out of the respective first holding bodies 131 of the first holding part 13, and sends thereof to the not-shown collection part where the printed can bodies 100 are collected. On the other hand, the other-side second supply/discharge part 24 receives the can bodies 100 from the storage part where the unprinted can bodies 100 are stored, and fits the can bodies 100 over the respective second holding bodies 141 of the second holding part 14. Consequently, the can bodies 100 are not held by the respective first holding bodies 131 of the first holding part 13, whereas the can bodies 100 are held by the respective second holding bodies 141 of the second holding part 14.

Next, as shown in FIG. 4, the can bodies 100 held by the second holding part 14 are rotated (S106).

In the exemplary embodiment, the second holding part 14 has the plural second holding bodies 141, and holds the plural can bodies 100. Then, the second holding part 14 synchronizes all of the plural can bodies 100 with one another, and rotates thereof around the axial direction as the rotation axes. In addition, in the exemplary embodiment, the plural first holding bodies 131 of the first holding part 13 rotate simultaneously with the rotation of the plural second holding bodies 141 of the second holding part 14. At this time, as viewed from one of the front side and the rear side in the second direction, the second holding body 141 and the first holding body 131 rotate in the directions opposite to each other.

Then, as shown in FIG. 4, the moving part 11 is moved from the other side to the one side (S107).

Further, printing is performed on the can bodies 100 held by the second holding part 14 (S108).

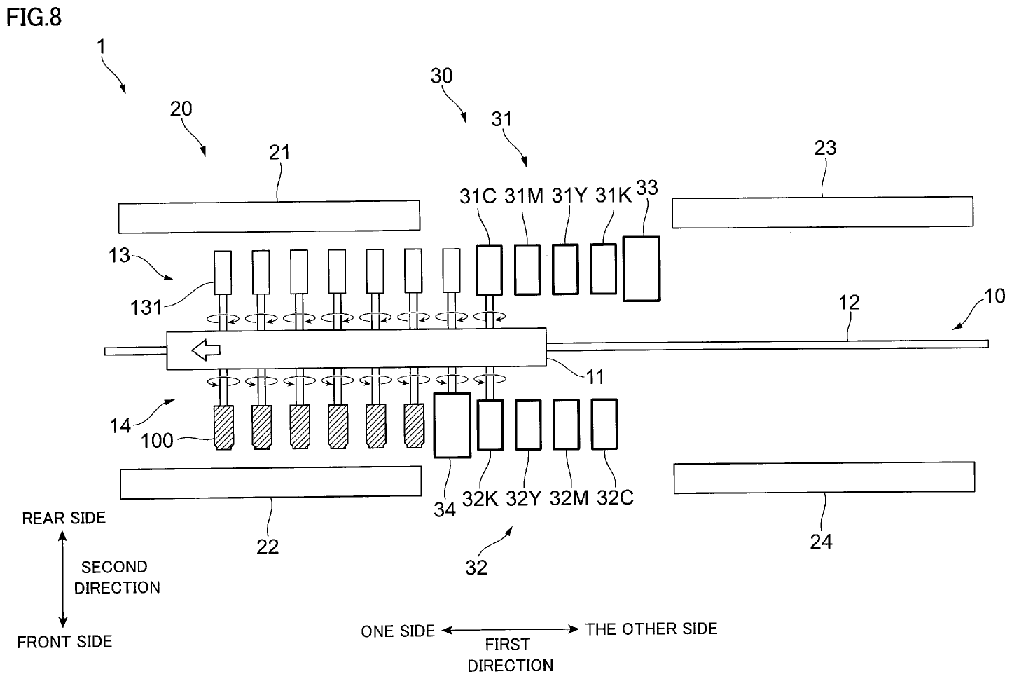

Specifically, as shown in FIG. 8, the moving part 11 sequentially locates each of the plural can bodies 100 held by the second holding part 14 below the second cyan head 32C, the second magenta head 32M, the second yellow head 32Y, and the second black head 32K of the second printing unit 32. Then, each of the second cyan head 32C, the second magenta head 32M, the second yellow head 32Y, and the second black head 32K performs printing on the facing can body 100, which is rotated at least once in the circumferential direction.

In the state of being located below the second light irradiation part 34, the can body 100 having been subjected to printing in four colors is irradiated by the second light irradiation part 34 with ultraviolet light while being rotated at least once in the circumferential direction. This cures the inks of cyan, magenta, yellow, and black on the can body 100.

As described above, the printing on all of the plural can bodies 100 held by the second holding part 14 is completed.

Note that, when the moving part 11 moves from the other side to the one side, and printing is performed by the second printing unit 32 on the can bodies 100 held by the second holding part 14, the first holding part 13 passes through the first printing unit 31. However, the first holding part 13 in the exemplary embodiment holds no can body 100, and the printing by the first printing unit 31 is not performed for the first holding part 13.

Then, as described above, when the printing on the can body 100 held by the second holding part 14 in S108 is completed, the process returns to S101 again. In S101, the printed can bodies 100 are discharged from the second holding part 14, and unprinted can bodies 100 are supplied to the first holding part 13. Then, the processes on and after S102 will be repeated.

As described above, in the printing device 1, the moving part 11 causes the first holding part 13 and the second holding part 14 to perform reciprocating movement along the first direction to turn between the one side and the other side, and the printing is performed on the can bodies 100 using the first printing unit 31 and the second printing unit 32. Then, in the printing device 1 of the exemplary embodiment, the moving route of the moving part 11 does not include a route formed by a bending part, such as an arc shape, and the moving part 11 moves linearly; therefore, the movement of the first holding part 13 and the second holding part 14 is less likely to be affected by the distortion. In addition, by adopting the configuration to perform the reciprocating movement to turn between the one side and the other side in the first direction, upsizing of the printing device 1 in the first direction is suppressed.

Note that, in the above-described exemplary embodiment, the printing in the plural colors are sequentially performed on the can body 100 by fixing the position of the printing part 30 and causing the moving part 11 to carry out the reciprocating movement in the first direction; however, the present invention is not limited to the mode. For example, the printing in the plural colors may be sequentially performed on the can body 100 by fixing the position of a structural part, which corresponds to the first holding part 13 and the second holding part 14 in the exemplary embodiment, to hold the can bodies 100, and causing the printing part 30 to perform the reciprocating movement in the first direction by the moving part 11.

In addition, in the above-described exemplary embodiment, the mandrels 132 of the first holding bodies 131 and the mandrels 142 of the second holding bodies 141 face away from each other, and each extend outwardly; however, the present invention is not limited to the mode. For example, the mandrels 132 of the first holding bodies 131 and the mandrels 142 of the second holding bodies 141 may be provided to extend inwardly and face each other.

Further, in the above-described exemplary embodiment, the axial direction of the can body 100 held by the first holding part 13 or the second holding part 14 is along the direction crossing the first direction (that is, the second direction), which is the moving direction of the moving part 11; however, the present invention is not limited to the mode. For example, the axial direction of the can body 100 held by the first holding part 13 or the second holding part 14 may be along the first direction. In this case, the orientation of the first printing unit 31 and the second printing unit 32 may be arranged in accordance with the axial direction of the can body 100.

Note that, in the printing part 30 of the printing device 1 in the above-described exemplary embodiment, the first light irradiation part 33 and the second light irradiation part 34 are provided to the first printing unit 31 and the second printing unit 32, respectively; however, the first light irradiation part 33 and the second light irradiation part 34 are not the essential configurations. The printing device 1 may discharge the can body 100, on which the printing has been performed by the first printing unit 31 or the second printing unit 32, from the supply/discharge part 20 before the first light irradiation part 33 or the second light irradiation part 34 performs ink curing processing. In this case, the ink curing processing using the first light irradiation part 33 and the second light irradiation part 34 may be separately performed on the discharged can body 100.

So far, the exemplary embodiment has been described, but the technical scope of the present invention is not limited to the scope of the above-described exemplary embodiment. It is obvious from the following claims that various modifications and improvements added to the above-described exemplary embodiment are also included in the technical scope of the present invention.

### REFERENCE SIGNS LIST

1 Printing device
10 Conveyance part
11 Moving part
12 Guide part
13 First holding part
14 Second holding part
20 Supply/discharge part
30 Printing part
31 First printing unit
32 Second printing unit
40 Control part
100 Can body
131 First holding body
132 Mandrel
141 Second holding body
142 Mandrel

1. A printing device comprising:
a holding part holding a plurality of can bodies in a state in which the plural can bodies are arranged in one linear direction;
a printing part performing printing on the can bodies held by the holding part; and
a moving part causing the holding part to perform a reciprocating movement relative to the printing part in the one direction.

2. The printing device according to claim 1, wherein
the holding part comprises:
a first holding part provided at one end side in a crossing direction crossing the one direction to hold the plurality of can bodies; and
a second holding part provided at the other end side in the crossing direction to hold the plurality of can bodies.

3. The printing device according to claim 2, wherein
the first holding part rotates the can bodies held by the first holding part in a specific direction, and,
when the first holding part rotates the can bodies in the specific direction, the second holding part rotates the can bodies held by the second holding part in a direction opposite to the specific direction.

4. The printing device according to claim 2, wherein a portion of the first holding part, where the can bodies are attached and detached, is provided at the one end side, and a portion of the second holding part, where the can bodies are attached and detached, is provided at the other end side.

5. The printing device according to claim 2, wherein
the printing part comprises:
a first printing part including a first color part performing printing in a first color on the can bodies and a second color part performing printing in a second color on the can bodies, the can bodies being held by the first holding part; and
a second printing part including a first color part performing printing in the first color on the can bodies and a second color part performing printing in the second color on the can bodies, the can bodies being held by the second holding part.

6. The printing device according to claim 5, wherein the moving part moves the holding part from one side to the other side in the one direction when the first printing part performs printing on the can bodies, and moves the holding part from the other side to the one side when the second printing part performs printing on the can bodies.

7. The printing device according to claim 6, wherein, in the first printing part, the first color part and the second color part are arranged in this order from the one side to the other side, and, in the second printing part, the first color part and the second color part are arranged in this order from the other side to the one side.

8. The printing device according to claim 1, further comprising:
a first mechanical part disposed at one side of the printing part in the one direction to supply and discharge the can bodies to and from the holding part; and
a second mechanical part disposed at the other side of the printing part in the one direction to supply and discharge the can bodies to and from the holding part, wherein
the moving part causes the holding part to perform a reciprocating movement with respect to the printing part with the first mechanical part and the second mechanical part as turning points.

9. The printing device according to claim 3, wherein
the printing part comprises:
a first printing part including a first color part performing printing in a first color on the can bodies and a second color part performing printing in a second color on the can bodies, the can bodies being held by the first holding part; and
a second printing part including a first color part performing printing in the first color on the can bodies and a second color part performing printing in the second color on the can bodies, the can bodies being held by the second holding part.

10. The printing device according to claim 4, wherein
the printing part comprises:
a first printing part including a first color part performing printing in a first color on the can bodies and a second color part performing printing in a second color on the can bodies, the can bodies being held by the first holding part; and
a second printing part including a first color part performing printing in the first color on the can bodies and a second color part performing printing in the second color on the can bodies, the can bodies being held by the second holding part.

11. The printing device according to claim 9, wherein the moving part moves the holding part from one side to the other side in the one direction when the first printing part performs printing on the can bodies, and moves the holding part from the other side to the one side when the second printing part performs printing on the can bodies.

12. The printing device according to claim 10, wherein the moving part moves the holding part from one side to the other side in the one direction when the first printing part performs printing on the can bodies, and moves the holding part from the other side to the one side when the second printing part performs printing on the can bodies.

13. The printing device according to claim 11, wherein, in the first printing part, the first color part and the second color part are arranged in this order from the one side to the other side, and, in the second printing part, the first color part and the second color part are arranged in this order from the other side to the one side.

14. The printing device according to claim 12, wherein, in the first printing part, the first color part and the second color part are arranged in this order from the one side to the other side, and, in the second printing part, the first color part and the second color part are arranged in this order from the other side to the one side.
